(19) United States
(12) Patent Application Publication
(10) Pub. No.: US 2015/0035180 A1
(43) Pub. Date: Feb. 5, 2015

(54) METHOD FOR FABRICATING AN ARRAYED OPTICAL ELEMENT

(71) Applicant: FORWARD OPTICS CO., LTD., Taichung City (TW)

(72) Inventors: Wei Shen, Taichung City (TW); Yuan-Lin Lee, Taichung City (TW)

(73) Assignee: Forward Optics Co., LTD., Taichung City (TW)

(21) Appl. No.: 13/958,200

(22) Filed: Aug. 2, 2013

(51) Int. Cl. B29C 45/14; B29C 47/00

(52) U.S. Cl. CPC B29C 45/14; B29C 47/0004; B29K 2105/0079
USPC 264/1.7

(57) ABSTRACT

A method for fabricating an arrayed optical element includes: forming a light blocking frame using a first material that has a heat deflection temperature; placing the light blocking frame into a cavity of a mold; and injecting a second material into the mold to form a lens unit that is integrally connected to the light blocking frame, the second material being an optical plastic material and having a forming temperature lower than the heat deflection temperature of the first material.

### BACKGROUND OF THE INVENTION

1. Field of the Invention

The invention relates to an arrayed optical element, more particularly to a method for fabricating an arrayed optical element.

2. Description of the Related Art

A conventional imaging apparatus (e.g., as disclosed in US20110122308 A1) includes two lens wafers, each including a plurality of optical elements arranged in an array, and a plurality of light-blocking spacers used for separating the optical members from one another so as to form a plurality of optical channels.

During fabrication of the conventional imaging apparatus, two different molds are respectively used to form the lens wafers and the light-blocking spacers, which are then assembled together. Since the lens wafers and the light-blocking spacers are independent, separate components, offsets are inevitable during assembly, thus affecting the positioning of the lens wafers along an optical axis. Furthermore, due to the abutment of the light-blocking spacers against the lens wafers, the positioning of the lens wafers along the optical axis is directly affected by the light-blocking spacers, where offsets in height among the light-blocking spacers adversely affect the positioning of the lens wafers along the optical axis.

In addition, when used in handheld devices (e.g. smart phones), the compact size of the conventional imaging apparatus increases the difficulty in assembly operations.

### SUMMARY OF THE INVENTION

Therefore, the object of the present invention is to provide an improved method for fabricating an arrayed optical element that can eliminate the aforesaid drawbacks of the prior art.

According to the present invention, there is provided a method for fabricating an arrayed optical element, comprising the steps of:

(a) forming a light blocking frame using a first material, the first material being one of a material with low light transmittance and a non-light transmissive material and having a heat deflection temperature, the light blocking frame including a bottom plate that is formed with a plurality of through holes arranged into an array, a surrounding wall that is integrally connected to the bottom plate and that extends in an upward direction along an optical axis, and at least one partition wall that is integrally connected to the bottom plate and the surrounding wall and that extends in the upward direction, the surrounding wall and the at least one partition wall cooperating to define a plurality of spaced apart optical channels, each of the optical channels being in spatial communication with a respective one of the through holes;

(b) placing the light blocking frame thus formed in step (a) into a cavity of a mold; and

(c) injecting a second material into the mold to form a lens unit that is integrally connected to the light blocking frame, the second material being an optical plastic material and having a forming temperature lower than the heat deflection temperature of the first material, the lens unit including a substrate that has a top side, which abuts against a bottom side of the bottom plate of the light blocking frame, and a plurality of upper positioning walls that are integrally connected to the top side of said substrate and that extend in the upward direction, the substrate including a plurality of lens elements, each of which is aligned with a respective one of the through holes, each of the upper positioning walls having an inner side that abuts against an outer side of the surrounding wall, a top side of each of said upper positioning walls being not lower than the top side of said surrounding wall in the upward direction.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart showing steps of the preferred embodiment of the method for fabricating an arrayed optical element according to the present invention;

FIG. 2 is a perspective view showing a light blocking frame fabricated by the preferred embodiment;

FIG. 3 is a schematic sectional view of a mold having the light blocking frame received therein and used by the preferred embodiment;

FIG. 4 is a perspective view showing an arrayed optical element fabricated by the preferred embodiment;

FIG. 5 is a schematic sectional view showing the arrayed optical element; and

FIG. 6 is a schematic sectional view showing a lens array module incorporating a plurality of the arrayed optical elements.

### DETAILED DESCRIPTION OF THE PREFERRED EMBODIMENT

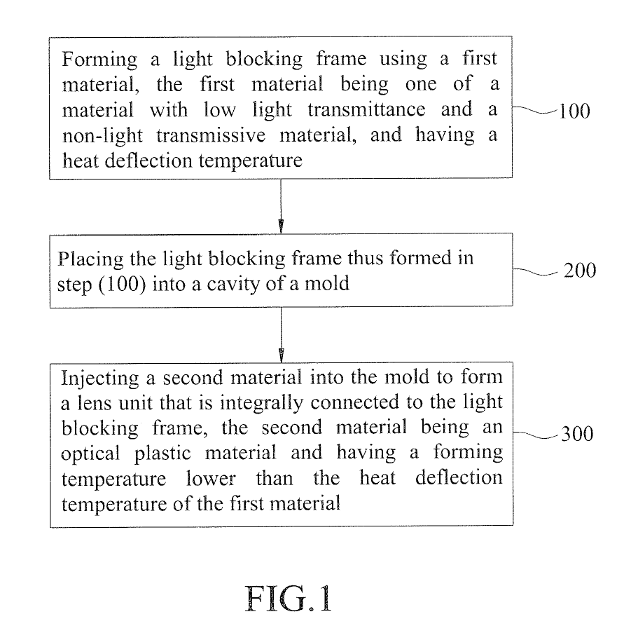

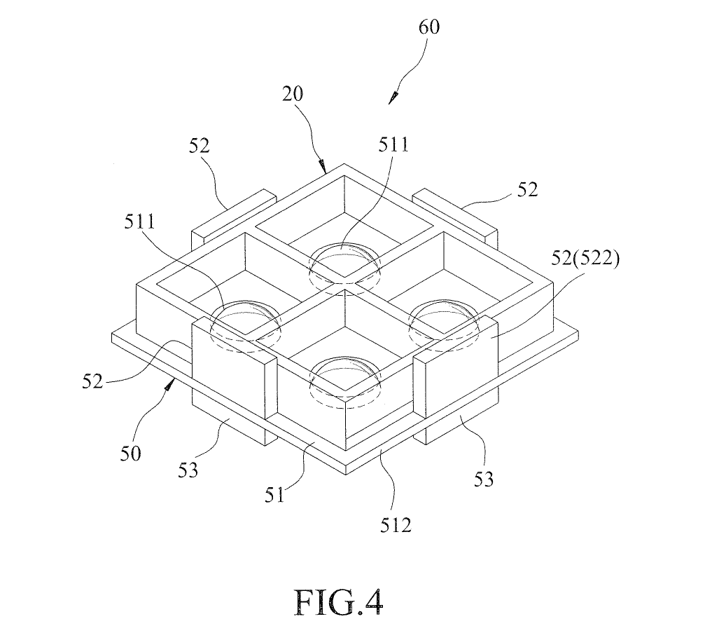

Referring to FIGS. 1 and 4, the preferred embodiment of a method for fabricating an arrayed optical element 60 according to the present invention includes the following steps.

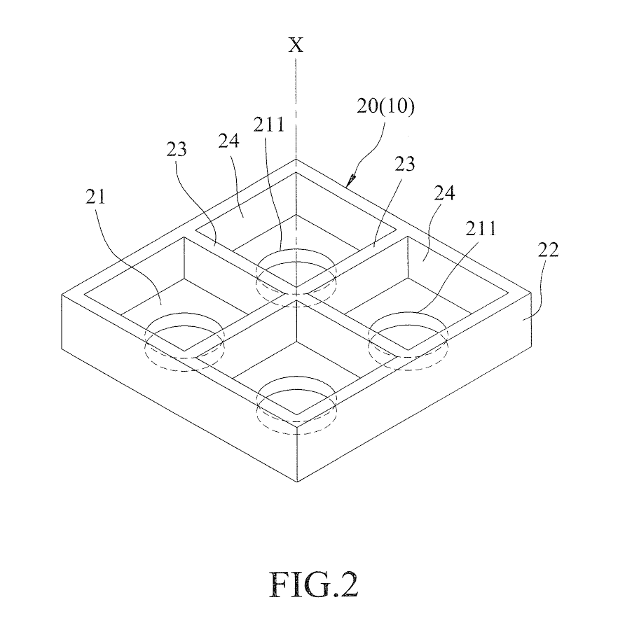

In step 100, with reference to FIGS. 1 and 2, a first material 10 is used to form a light blocking frame 20. The first material 10 is one of a material with low light transmittance and a non-light transmissive material, and has a heat deflection temperature.

In this embodiment, the first material 10 is selected from the group consisting of metal, thermoplastic, thermosetting plastic and silicone resin, and is preferably a liquid crystal polymer (LCP) such as Zenite® 5130L BK010 supplied by DuPont, and the heat deflection temperature thereof ranges between 270° C. and 350° C.

The light blocking frame 20 includes a bottom plate 21, a surrounding wall 22 and a plurality of partition walls 23. The bottom plate 21 is formed with a plurality of through holes 211 arranged into an array. The surrounding wall 22 is integrally connected to the bottom plate 21 and extends in an upward direction along an optical axis (X). The partition walls 23 are integrally connected to the bottom plate 21 and surrounding walls 22, and extend in the upward direction. The surrounding wall 22 and the partition walls 23 cooperate to define a plurality of spaced apart optical channels 24 in spatial communication with the corresponding through holes 211. It can be understood that when there is only one partition wall 23, multiple (i.e., two) optical channels 24 can still be defined with the surrounding wall 22.

In this embodiment, the light blocking frame 20 has a first height (H1) extending along the optical axis (X). The light blocking frame 20 is formed by injection molding, where the first material 10 is injected into a mold (not shown) for molding. It is noted that when the first material 10 is silicone resin, the light blocking frame 20 can also be formed by extrusion, where the first material 10 is extruded through a die (not shown).

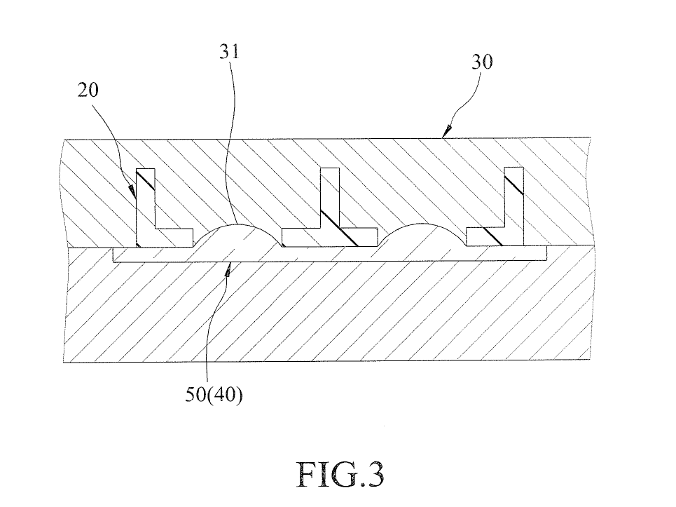

In step 200, with reference to FIGS. 1 and 3, the light blocking frame 20 thus formed in step 100 is placed into a cavity 31 of a mold 30. It is noted that when the first material 10 is silicone resin, the light blocking frame 20 would have a certain degree of resiliency and can be placed with ease into the cavity 31. Therefore the light blocking frame 20 may have a greater dimensional tolerance.

In step 300, with reference to FIGS. 1 and 3, a second material 40 is injected into the mold 30 to form a lens unit 50 that is integrally connected to the light blocking frame 20. The second material 40 is an optical plastic material and has a forming temperature lower than the heat deflection temperature of the first material 10.

In this embodiment, the second material 40 may be PMMA (polymethyl methacrylate) having a forming temperature of between 75° C. and 95° C. and supplied by Mitsubishi, PC-AD5503 (polycarbonate) having a forming temperature of between 115° C. and 125° C. and supplied by Teijin, ZEONEX 480R having a forming temperature of between 115° C. and 125° C. and supplied by ZEONEX, or ULTEM-1010 having a forming temperature of between 190° C. and 200° C. and supplied by SABIC, among others.

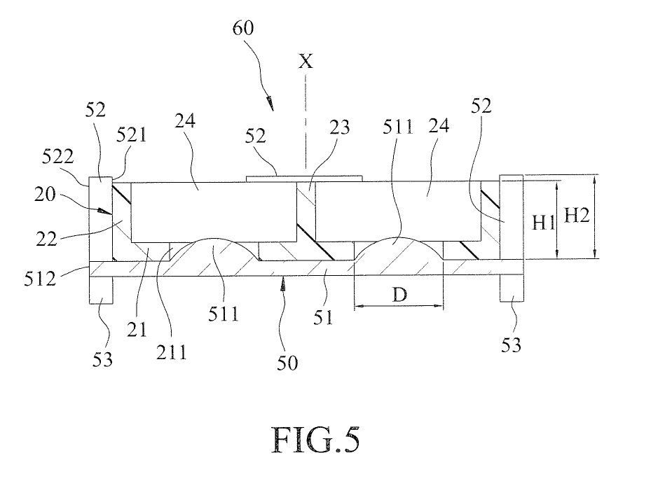

Referring to FIGS. 4 and 5, the lens unit 50 includes a substrate 51 that has a top side abutting against a bottom side of the bottom plate 21 of the light blocking frame 20, a plurality of upper positioning walls 52 that are integrally connected to the top side of the substrate 51 and that extend in the upward direction, and a plurality of lower positioning walls 53 that are integrally connected to the bottom side of the substrate 51 and that extend in a downward direction along the optical axis (X) opposite to the upward direction. The top side of each of the upper positioning walls 52 is not lower than the top side of the surrounding wall 22 in the upward direction. It should be noted herein that the lower positioning walls 53 are optional in other embodiments of this invention.

The substrate 51 includes a plurality of lens elements 511, each of which is aligned with a respective through hole 211, and an outer peripheral edge 512. Each of the lens elements 511 has a clear aperture (D).

Each of the upper positioning walls 52 has an inner side 521 that abuts against an outer side of the surrounding wall 22 and an outer side 522 that is opposite to the inner side 521. The outer peripheral edge 512 of the substrate 51 is disposed within a boundary defined cooperatively by the outer sides 522 of the upper positioning walls 52. In this embodiment, the outer side 522 is flat.

In this embodiment, each of the upper positioning walls 52 has a second height (H2) extending along the optical axis (X) and greater than the first height (H1), wherein a difference between the first and second heights (H1, H2) is not greater than 50 μm, and a ratio between the first height (H1) and the clear aperture (D) of each of the lens elements 511 is within the range of between 0.2 and 2.0, i.e., 0.2≦H1/D≦2.0. It is understood that if this ratio is below 0.2, there would be inadequate light shielding, and if this ratio is greater than 2.0, the overall height of the arrayed optical element 60 would be increased.

Therefore, the arrayed optical element 60 is formed by integrally connecting the lens unit 50 and the light blocking frame 20. In this embodiment, the arrayed optical element 60 has a length and width not greater than 3 mm, and a height not greater than 2 mm.

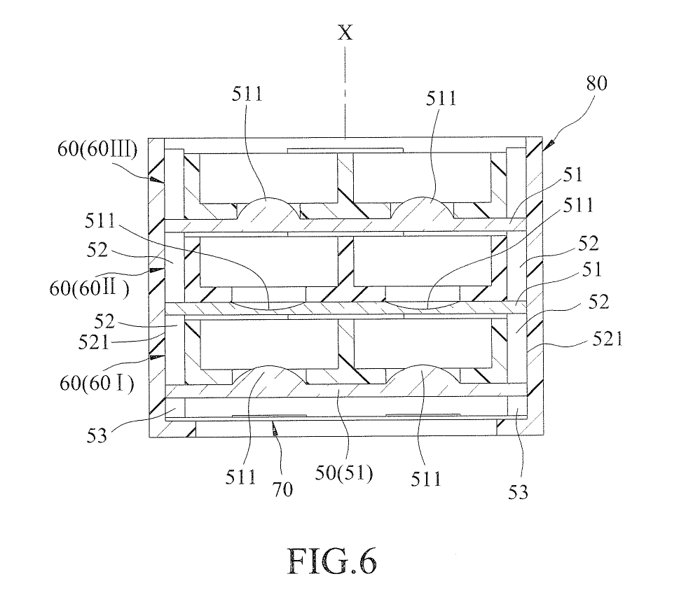

During assembly of a lens array module that incorporates the arrayed optical elements 60 fabricated by this invention, with reference to FIG. 6, multiple arrayed optical elements 60 can be fabricated and then stacked with a light sensor array unit 70 inside a housing 80. It should be noted that only the bottommost arrayed optical element 60I (i.e. the one closest to the light sensor array unit 70) includes the lower positioning walls 53, such that the lower positioning walls 53 thereof abut against the light sensor array unit 70 so as to set a distance between the lens elements 511 of the bottommost arrayed optical element 60I and the light sensor array unit 70 along the optical axis (X). The upper positioning walls 52 of each of the arrayed optical elements 60I, 60II, abut against the substrate 51 of an upper adjacent one of the arrayed optical elements 60II, 60III to set a distance between the lens elements 511 of adjacent pairs of the arrayed optical elements 60I, 60II, 60III along the optical axis (X).

Simultaneously, the outer sides 522 of the upper positioning walls 52 of the arrayed optical elements 60I, 60II, 60III abut against the inner side of the housing 80 to efficiently position the lens elements 511 of the arrayed optical elements 60I, 60II, 60III along an horizontal direction perpendicular to the upward direction. As a result, the position of the lens elements 511 of the arrayed optical elements 60I, 60II, 60III is accurately controlled through this construction to satisfy the optical performance requirements.

Through the aforementioned description, the advantages of this invention can be summarized as follows:

(1) Since the lens unit 50 is fabricated to be integrally connected to the light blocking frame 20, no further assembly operations are needed for the arrayed optical element 60. When compared to the prior art, the present invention has simplified the fabrication procedure of the arrayed optical element 60. In addition, assembly tolerance affecting the positioning of the lens elements 511 along the optical axis (X) is completely eliminated. As such, this invention is also suitable for fabricating small arrayed optical elements 60 for compact applications, such as in handheld devices.

(2) A first material 10 having a heat deflection temperature is used for molding the light blocking frame 20, and then a second material 40 having a forming temperature that is lower than the heat deflection temperature of the first material 10 is used for molding the lens unit 50 to be integrally connected to the light blocking frame 20. Since the forming temperature of the second material 40 is lower than the heat deflection temperature of the first material 10, the light blocking frame 20 will not be deformed during the formation of the lens unit 50.

(3) Since the second height (H2) of the upper positioning walls 52 of the lens unit 50 is greater than the first height (H1) of the light blocking frame 20, only the upper positioning walls 52 need to be controlled in terms of height tolerance along the optical axis (X) to effectively maintain the positioning of the lens units 50 along the optical axis (X), making manufacturing and assembly processes of a lens array module incorporating the arrayed optical element 60 fabricated in accordance with this invention more convenient than those of the prior art.

(4) Since the lens unit 50 is formed integrally as one piece, assembly tolerance between the upper (lower) positioning walls 52 (53) and the lens elements 511 is completely eliminated. Moreover, with the upper positioning walls 52 being integrally formed on the corresponding substrate 51, the resultant lens unit 50 is prevented from being affected by dimensional tolerances of other components, such as the light blocking frame 20. Therefore, the novel use of the upper positioning walls 52 to accurately control and maintain the positioning of the lens elements 511 improves the optical properties of the lens array module incorporating the arrayed optical element 60 fabricated in accordance with this invention.

(5) The ratio of the first height (H1) of the light blocking frame 20 and the clear aperture (D) of the lens elements 511 ranges between 0.2 and 2.0, preventing the light blocking frame 20 from being too low, thus causing inadequate shielding effects, or from being too high, thus increasing the overall height of the lens array module incorporating the arrayed optical element 60 fabricated in accordance with this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for fabricating an arrayed optical element, comprising the steps of:
(a) forming a light blocking frame using a first material, the first material being one of a material with low light transmittance and a non-light transmissive material, and having a heat deflection temperature, the light blocking frame including a bottom plate that is formed with a plurality of through holes arranged into an array, a surrounding wall that is integrally connected to the bottom plate and that extends in an upward direction along an optical axis, and at least one partition wall that is integrally connected to the bottom plate and the surrounding wall and that extends in the upward direction, the surrounding wall and the at least one partition wall cooperating to define a plurality of spaced apart optical channels, each of the optical channels being in spatial communication with a respective one of the through holes;
(b) placing the light blocking frame thus formed in step (a) into a cavity of a mold; and
(c) injecting a second material into the mold to form a lens unit that is integrally connected to the light blocking frame, the second material being an optical plastic material and having a forming temperature lower than the heat deflection temperature of the first material, the lens unit including a substrate that has a top side abutting against a bottom side of the bottom plate of the light blocking frame, and a plurality of upper positioning walls that are integrally connected to the top side of said substrate and that extend in the upward direction, the substrate including a plurality of lens elements, each of which is aligned with a respective one of the through holes, each of the upper positioning walls having an inner side that abuts against an outer side of the surrounding wall, a top side of each of said upper positioning walls being not lower than the top side of said surrounding wall in the upward direction.

2. The method of claim 1, wherein the light blocking frame formed in step (a) has a first height extending along the optical axis, and each of the lens elements of the lens unit formed in step (c) has a clear aperture, where 0.2≦the first height/the clear aperture≦2.0.

3. The method of claim 2, wherein each of the upper positioning walls of the lens unit formed in step (c) has a second height extending along the optical axis and greater than the first height, a difference between the first and second heights being not greater than 50 μm.

4. The method of claim 1, wherein each of the upper positioning walls of the lens unit formed in step (c) has an outer side distal from the surrounding wall of the light blocking frame and opposite to the inner side thereof, an outer peripheral edge of the substrate being disposed within a boundary defined cooperatively by the outer sides of the upper positioning walls.

5. The method of claim 4, wherein the outer side of each of the upper positioning walls of the lens unit formed in step (c) is flat.

6. The method of claim 4, wherein the lens unit formed in step (c) further includes a plurality of lower positioning walls integrally connected to the bottom side of the substrate and extending in a downward direction along the optical axis that is opposite to the upward direction.

7. The method of claim 1, wherein, in step (a), the first material is selected from the group consisting of metal, thermoplastic, thermosetting plastic and silicone resin.

8. The method of claim 7, wherein, in step (a), the first material is a liquid crystal polymer.

9. The method of claim 1, wherein, in step (a), the light blocking frame is formed by injection molding.

10. The method of claim 1, wherein, in step (a), the light blocking frame is formed by extrusion.

11. The method of claim 1, wherein, the arrayed optical element thus formed after completion of step (c) has a length and a width each not greater than 3 mm, and a height not greater than 2 mm.
